(19) United States
(12) Patent Application Publication
(10) Pub. No.: US 2007/0283587 A1
(43) Pub. Date: Dec. 13, 2007

(54) ANGLE MEASURING DEVICE

(76) Inventor: John Cerwin, Gurnee, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/756,949

(22) Filed: Jun. 1, 2007

Related U.S. Application Data
(60) Provisional application No. 60/767,541, filed on Jun. 8, 2006.

(51) Int. Cl. B43L 7/10

(52) U.S. Cl. 33/471

(57) ABSTRACT

An angle measuring device with two pivotable arms connected at a common point is disclosed. The first arm contains a rigidly linked shaft which connects the first arm to a second arm rotatable relative to the first arm. A first electronic sensor, such as a magnetic rotary encoder, determines the angle between the arms. Optionally, a second electronic sensor, such as an accelerometer, determines the angle of orientation of an arm with reference to the plane of the Earth. The microcontroller can be used to aggregate the output of the magnetic rotary encoder with the accelerometers, so as to calculate the angle from the plane of the Earth up to the first arm of the angle measuring device.

### CROSS-REFERENCE TO RELATED APPLICATION

This application claims the benefit of the following U.S. Provisional Patent Application No. 60/767,541, filed Jun. 8, 2006, which is hereby incorporated by reference in its entirety.

### BACKGROUND OF THE INVENTION

The present invention relates to angle measuring devices, and more specifically to an electronic angle measuring device.

### DESCRIPTION OF THE RELATED ART

In the construction, surveying, engineering, medical, and manufacturing fields, it is common practice to use a measurement tool to capture or establish angular measurements.

One such angle measuring device is disclosed in U.S. Pat. No. 4,513,512, issued to Fischer. Fischer describes an angle-measuring instrument which includes two arms, which are interconnected in such a way that they can be pivoted about a common shaft, and an indicator for the angle of spread of the two arms. The shaft is rigidly connected with one of the arms, and drives the drive gear of a transmission gearing which is arranged in the at least partially hollow second arm. As a function of the angular position of the two arms relative to one another, the transmission gearing moves the indicator, which is also disposed in the hollow second arm, and in the indicating region of which a viewing window is arranged in the hollow second arm. Fischer has the disadvantage of a purely mechanical system based on physical transmission gearing. Such gearing tends to wear over time and become less precise. Transmission gearing is also susceptible to manufacturing errors, deflection under load, differential expansion between the gears and the housing, and backlash, all of which can contribute to imprecise angular measurements. Fischer's transmission gearing is only able to resolve to 360 degrees. Furthermore, Fischer uses a mechanical indicator for angular feedback. Mechanical indicators are not as precise as digital.

Another angle measuring device is disclosed in U.S. Pat. No. 6,104,480, issued to Matzo, et al. According to the Matzo patent, the electronic angle measuring device comprising two legs, a hinge supporting the legs turnably relative to one another about a common axis, at least one rotor, drive unit driving the rotor rotatably about a rotary axis coincided with the turning axis, reference points associated with the legs, at least one reference mark rotating together with the rotor and passing the reference points over a rotary path, the hinge having a central bearing part which is fixedly connected with one of the legs, and a bearing receptacle provided for the other of the legs and arranged concentrically to the turning axis. Matzo has the disadvantage of a system that requires multiple sensors (referred to as reference points in the specification) operating in conjunction with a large rotor; this results in an angle measuring device that is too large for many angle measuring activities in the construction, medical, and manufacturing fields. The preferred implementation of Matzo's system also uses light-based sensors as reference points. Such sensors are adversely affected by the typical environmental conditions in a construction setting, such as dirt, dust, water, etc. The commercial implementation of Matzo's system is also limited to accuracy of +/−0.1 degrees. Furthermore, Matzo's system does not include an accurate way to determine the inclination or position of the base arm (the arm from which the angular measurement originates) with reference to the plane of the Earth. This weakness is apparent in the construction field, where the true angle of measurement must be taken from the plane of the Earth to another surface.

### SUMMARY

In view of the deficiencies described above, it is an object of the present invention to provide an angle measuring device which avoids the disadvantages of the prior art.

More particularly, it is an object of the present invention to provide an angle measuring device that can provide cost-favorable angle measurement with a high measuring accuracy in a compact form.

It is a further object of the present invention to provide an angle measuring device that is resistant to adverse environment conditions, such as those in the construction, medical, and manufacturing settings.

It is a further object of the present invention to provide an angle measuring device with multiple angle measurement mechanisms that can be used independently, or in conjunction with each other.

The present invention is an angle measuring device with two pivotable arms that are connected at a common point. The first arm contains a rigidly linked shaft which connects the first arm to a second arm in such a way that the second arm can rotate on the shaft with reference to the first arm. A first electronic sensor is used to determine the angle between the first and second arms. This first electronic sensor can be, for example, but is not limited to, a magnetic rotary encoder or an optical rotary encoder. In various preferred embodiments, the first electronic sensor is a magnetic rotary encoder.

In various preferred embodiments, the shaft contains a dual-pole magnet that is fixed in position, and the second arm contains a magnetic rotary encoder which is mounted near the dual-pole magnet at the end of the shaft. The magnetic rotary encoder is electrically connected to a microcontroller, or other computing and processing device. A printed circuit board, or other electrical connection means, electrically connects the magnetic rotary encoder, the microcontroller, a feedback device, and a power source.

Preferably, the two-pole magnet is small in circumference, and the magnetic rotary encoder is also small. This allows the shaft to be very small in diameter and length. Furthermore, since the two-pole magnet does not need to physically contact the magnetic rotary encoder, these two elements can be sealed, and are thus resistance to adverse environmental conditions.

Electronic output from the magnetic rotary encoder is used to determine the rotational position of the magnet, and thus the shaft that is rigidly connected to the first arm. The electronic output can be either fed directly to a feedback device, to a microcontroller, or other computing and processing device. The microcontroller, or other computing and processing device, is used to read the output of the magnetic rotary encoder.

In various preferred embodiments, the angle measuring device may include a second electronic sensor that uses gravity and or acceleration to determine the angle of orientation of either the first arm or the second arm with reference to the plane of the Earth. The second electronic sensor can include one or more accelerometers, where the accelerometers are mounted in device in such a manner that the accelerometers are mutually perpendicular to one another. The accelerometers are used to measure the relative direction to the gravitational force of the Earth. A full 360 degrees of orientation can be measured by using two accelerometers that are mounted perpendicularly to one another.

By utilizing the output of the first electronic sensor and the second electronic sensor, the microcontroller can measure the angles between multiple planes concurrently, such as the angle between the planes of the first arm and the second arm and the plane of the Earth. Furthermore the microcontroller, can be used to aggregate the output of the first electronic sensor and the second electronic sensor, so as to calculate the angle from the plane of the Earth up to the first arm of the angle measuring device.

The feedback device can be any one or any combination of visual or audible feedback mechanisms. In other various preferred embodiments, the angle measuring device may include hardware and software that provides for communication with an external computer or computing device, wherein the data from the first and second electronic sensors can be sent to the external computer or computing device. The power source is preferably a battery of some type known in the art, which would be integral to the device.

Other features and advantages of the invention will be apparent from the following detailed description taken in conjunction with the following figures, wherein like reference numerals represent like features.

### BRIEF DESCRIPTION OF THE FIGURES

FIG. 1 shows a front perspective view of an angle measuring device according to the present invention.

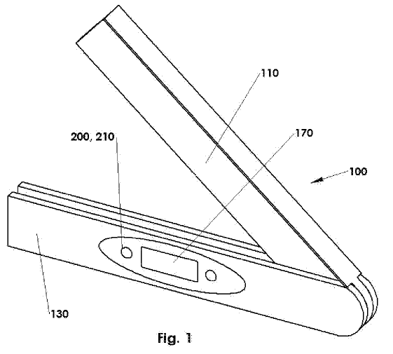

FIG. 2 shows a front perspective view of an angle measuring device according to the present invention with the front face removed so the internal components are visible.

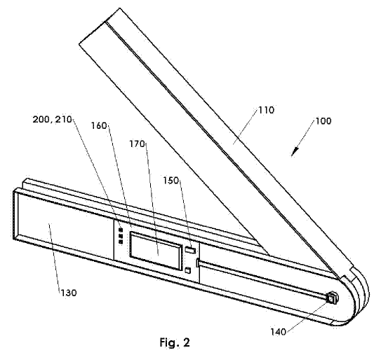

FIG. 3 shows an elbow or hinge mechanism, including the first sensor, of an angle measuring device according to the present invention.

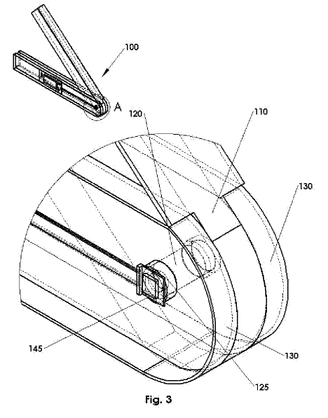

FIG. 4 shows a two-pole magnet in the shaft of the angle measure device according to the present invention.

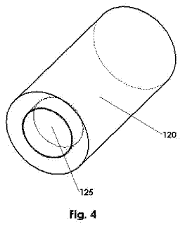

FIG. 5 shows a second sensor of an angle measuring device according to the present invention.

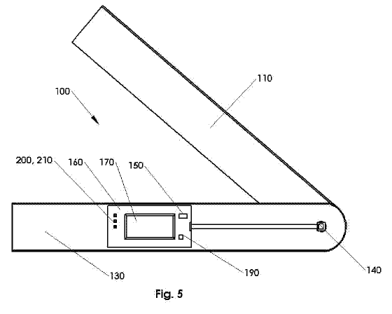

FIG. 6 shows an angle measuring device according to the present invention measuring against three different planes concurrently.

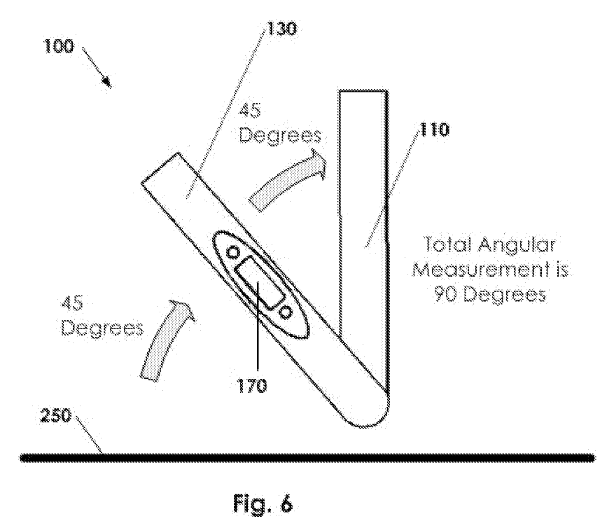

### DETAILED DESCRIPTION OF THE PREFERRED EMBODIMENTS

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is an angle measuring device 100 with two pivotable arms that are connected at a common point. The first arm 110 contains a rigidly linked shaft 120 which connects the first arm 110 to a second arm 130 in such a way that the second arm 130 can rotate on the shaft 120 with reference to the first arm 110. A first electronic sensor 140 is used to determine the angle between the first arm 110 and the second arm 130. This first electronic sensor 140 can be, for example, but is not limited to, a magnetic rotary encoder 145 or an optical rotary encoder. In various preferred embodiments, the first electronic sensor 140 is a magnetic rotary encoder 145.

In various preferred embodiments, the shaft 120 contains a dual-pole magnet 125 that is fixed in position, and the second arm 130 contains a magnetic rotary encoder 145 which is mounted near the dual-pole magnet 125 at the end of the shaft 120. The magnetic rotary encoder 145 is electrically connected to a microcontroller 150, or other computing and processing device. A printed circuit board 160, or other electrical connection means, electrically connects the magnetic rotary encoder 145, the microcontroller 150, a feedback device 170, and a power source (not shown).

Preferably, the two-pole magnet 125 is small in circumference, and the magnetic rotary encoder 145 is also small. This allows the shaft 120 to be very small in diameter and length. Furthermore, since the two-pole magnet 125 does not need to physically contact the magnetic rotary encoder 145, these two elements can be sealed, and are thus resistance to adverse environmental conditions. Further, a magnetic rotary encoder 145 can operate with resolution of 12 bits or higher. Such resolution would provide accuracy that is greater than 0.1 degrees (12 bits=4095 rotational position measurements).

Electronic output from the magnetic rotary encoder 145 is used to determine the rotational position of the magnet 125, and thus the shaft 120 that is rigidly connected to the first arm 110. The electronic output can be either fed directly to a feedback device 170, to a microcontroller 150, or other computing and processing device. The electronic output itself can be in a variety of formats known in the art, including, but not limited to, digital pulse-width, serial, and or analog.

The microcontroller 150, or other computing and processing device, is used to read the output of the first electronic sensor 140. This output can be can be of any type known in the art, such as digital pulses, analog signals, serial data, or 12C data. The microcontroller 150 then converts the output into meaningful angle data, such as radians, degrees, slope, percent of slope, or any type known in the art. The microcontroller 150 can be also used for stabilizing or filtering the output of the first electronic sensor 140, for establishing a zero-point, or base measurement point from which all angular measurements begin between the two-pole magnet 125 and magnetic rotary encoder 145.

By way of example and not as a limitation to the present invention, pulse-width position data obtained from the first electronic sensor 140 can be translated into a degree-based angle according to the following relationships:

### Step #1: Translate the pulse-width position data into a NUMBER that is between 0 and MAX_P:

$$POSITION = \frac{PWT * MAX\_P}{ST + TP} - 1$$

Where:

PWT is the time of the pulse width, which is a numeric representation of the position of the first arm 110 with respect to the second arm 130 as obtained by the electronic sensor 140. The pulse width can be an actual time in nano, micro, or milli seconds, or some other timing format, but must be in a format consistent to ST and TP.

MAX_P is the MAXIMUM number of positions that can be measured by the electronic sensor.

ST is the starting time for the PWT measurement. This can be an actual time in nano, micro, or milli seconds, or some other timing format, but must be in a format consistent to PWT and TP.

TP is the total period for the measurement. This can be an actual time in nano, micro, or milli seconds, or some other timing format, but must be in a format consistent to PWT and ST.

Step #2: Translate the POSITION from Step #1 into degrees:

DEGREES=POSITION*(360/MAX_{—}P)

Noise or output variation can be eliminated from the first electronic sensor 140 using Digital Signal Processing (DSP) techniques. There are many DSP techniques or DSP types known in the art. Such DSP techniques include, but are not limited to both simple “weighted average” calculations and more sophisticated techniques such as Infinite Impulse Response (IIR) Filters. As an example with regards to a simple “weighted average” technique, the relationship is preferably applied to the POSITION output of the first electronic sensor 140 prior to translating it into DEGREES:

CP=CP*(LPF−1)

NP=NP+CP

NP=NP/LPF

Where:

CP is the current position value obtained from the previous weighted average calculation.

NP is the new POSITION data obtained from Step #1, above.

LPF is the weighted average value.

A “zero angle measurement” can also be determined, regardless of the positions of the first arm 110 and the second arm 130 with regards to each other. There are many techniques known in the art that can be used to accomplish “zero angle measurement”. As an example, this relationship is preferably applied to the POSITION output of the first electronic sensor 140 prior to translating it into DEGREES:

POSITION=POSITION−ZP If (POSTION<0) THEN POSITION=POSITION+MAX_{—}P

### Where:

ZP is a previously established zero point.

MAX_P is the MAXIMUM number of positions that can be measured by the electronic sensor 140.

In various preferred embodiments, the angle measuring device 100 may include a second electronic sensor 190 that uses gravity and or acceleration to determine the angle of orientation of either the first arm 110 or the second arm 130 with reference to the plane of the Earth 250. The second electronic sensor 190 can include one or more accelerometers 195, where the accelerometers 195 are mounted in device in such a manner that the accelerometers 195 are mutually perpendicular to one another. The accelerometers 195 are used to measure the relative direction to the gravitational force of the Earth. A full 360 degrees of orientation can be measured by using two accelerometers 195 that are mounted perpendicularly to one another.

The accelerometers 195 can be conventional single or multiple axis accelerometers or preferably single or multiple axis micro-electro-mechanical system accelerometers. Micro-Electro-Mechanical Systems (MEMS) is the integration of mechanical elements, sensors, actuators, and electronics on a common silicon substrate through micro-fabrication technology. MEMS accelerometers are advantageous because they can be incorporated directly onto or into a small silicon chip at relatively low cost. To improve performance, thermal compensated accelerometers may be used.

The microcontroller 150, or other computing and processing device, can also be used to read the output of the second electronic sensor 190. This output can be can be of any type known in the art, such as digital pulses, analog signals, serial data, or 12C data. The microcontroller 150 then converts the output into meaningful angle data, such as radians, degrees, slope, percent of slope, or any type known in the art. The microcontroller 150 can be also used for stabilizing or filtering the output of the second electronic sensor 190, and for calibrating the second electronic sensor 190.

By utilizing the output of the of the first electronic sensor 140 and the second electronic sensor 190, the microcontroller 150, or other computing and processing device, can measure the angles between multiple planes concurrently, such as the angle between the planes of the first arm 110 and the second arm 130 and the plane of the Earth 250. Furthermore the microcontroller 150, or other computing and processing device, can be used to aggregate the output of the first electronic sensor 140 and the second electronic sensor 190, so as to calculate the angle from the plane of the Earth 250 up to the first arm 110 of the angle measuring device 100.

Calculating the inclination of the first arm 110 relative to the plane of the Earth 250 from the first electronic sensor 140 and the second electronic sensor 190 can be accomplished thought the following relationship:

TOTAL=ID+AD

### Where:

ID is the inclination in degrees as output from the second electronic sensor 190 in the second arm 130, which is the angle of inclination of the second arm 130 relative to the plane of the Earth 250.

AD is the angle of spread of first arm 110 and the second arm 130 relative to one another in degrees as output from the first electronic sensor 140.

The feedback device 170 can be any one or any combination of visual or audible feedback mechanisms. Visual feedback can be in any one or any combination of alpha, numeric, graphical or indicator formats. In various embodiments, a liquid crystal display displays the angles of rotation and or the distance measurements. A light emitting diode array or other visual feedback means known in the art may also be used to give visual feedback. Audible feedback can be in the form of buzzers or tones that activate when predetermined conditions are met, such as memorized angle. Voice synthesis may also be used for audible feedback.

In other various preferred embodiments, the angle measuring device 100 may include hardware and software that provides for communication with an external computer or computing device (not shown), wherein the data from the first electronic sensor 140 and second electronic sensor 190 can be sent to the external computer or computing device.

The angle measuring device 100 of the present invention can also incorporate buttons 200 and or switches 210, or other input and control means known in the art, that are used to turn the device 100 on and off and to access available functions programmed into the microcontroller 150 or computing and processing means.

The power source is preferably a battery of some type known in the art, which would be integral to the device. Having an integral power source eliminates the need for the device to be tethered to a power source via a power cord.

In various embodiments, additional features can be added, singularly or in combination, to the device. For example, device may include laser or other light projecting devices that project one or more lines of visible light from the device. Such lines can be used to effectively extend the edges of arms as well as assist in aligning the arms with one or more other objects.

While specific embodiments have been illustrated and described, numerous modifications come to mind without significantly departing from the spirit of the invention and the scope of protection is limited by the scope of the accompanying claims.

What is claimed is:

1. An angle measuring device comprising:
a first arm;
a first shaft rigidly connected to said first arm;
a second arm which is connected to said first arm via said first shaft in such a way as to be pivotable relative thereto;
a first electronic sensor having means for means of measuring an angle of spread between said first and said second arms, and
feedback device, operably connected to at least one of said first arm and said second arm.

2. The angle measuring device according to claim 1, wherein said first electronic sensor comprises a magnetic rotary encoder.

3. The angle measuring device according to claim 1, wherein said first electronic sensor comprises an optical rotary encoder.

4. The angle measuring device according to claim 1, wherein said feedback device comprises a video feedback system.

5. The angle measuring device according to claim 1, wherein the said feedback device comprises an audio feedback system.

6. The angle measuring device, according to claim 1, further comprising:
a computing and processing device, said computing and processing device having computer implemented means for obtaining data from said first electronic sensor, calculating said angle of spread between said first and said second arms based on the data from first electronic sensor, and means for outputting said calculated angle to said feedback device.

7. The angle measuring device according to claim 6, wherein said second arm further comprises:
a second electronic sensor for measuring an angle of inclination of said second arm relative to a plane of the Earth.

8. The angle measuring device according to claim 7, wherein said second electronic sensor comprises at least one accelerometer.

9. The angle measuring device according to claim 8, wherein said at least one accelerometer comprises a MEMS (Micro-Electro-Mechanical-System) accelerometer.

10. The angle measuring device according to claim 7, wherein the said data from said first electronic sensor and said second electronic sensors are combined to produce an aggregate angle of inclination of said first arm relative to the plane of the Earth.

11. The angle measuring device according to claim 6, further comprising means for connecting said device to an external computing device.

12. The angle measuring device according to claim 7, further comprising means for connecting said device to an external computing device.

13. The angle measuring device according to claim 11, wherein said data from said first electronic sensor is sent to said external computing device, and said external computing device has computer implemented means for collecting data.

14. The angle measuring device according to claim 12, wherein said data from said first electronic sensor and said second electronic sensors are sent to said external computing device, and said external computing device has computer implemented means for collecting data.

15. The angle measuring device according to claim 11, wherein said data from said first electronic sensor is sent to said external computing device, and said external computing device has computer implemented means for outputting said data in real-time.

16. The angle measuring device according to claim 12, wherein said data from said first electronic sensor and said second electronic sensors are sent to said external computing device, and said external computing device has computer implemented means for outputting said data in real-time.
